(19) United States
(12) Patent Application Publication
(10) Pub. No.: US 2021/0117804 A1
(43) Pub. Date: Apr. 22, 2021

(54) TECHNIQUE FOR CONFIGURING AND OPERATING A NEURAL NETWORK

(71) Applicant: e.solutions GmbH, Ingolstadt (DE)

(72) Inventors: THOMAS KOEHLER, NUERNBERG (DE); MATTHIAS STOCK, HEROLDSBACH (DE)

(21) Appl. No.: 17/074,072

(22) Filed: Oct. 19, 2020

(30) Foreign Application Priority Data
Oct. 22, 2019 (DE) 10 2019 007 340.1

(51) Int. Cl. G06N 3/08; G06N 3/04; H04L 29/08

(52) U.S. Cl. CPC G06N 3/084; H04L 67/10; G06N 3/04

(57) ABSTRACT

This disclosure relates to the configuration and operation of a neural network which comprises multiple successive layers. The successive layers thereby comprise an input layer, an output layer, and at least one hidden layer located between the input layer and the output layer. A method for configuring the neural network comprises partitioning the neural network into at least a first level and a second level which each comprise one of the layers or multiple of the layers which succeed one another, wherein the first level comprises at least the input layer, and the second level comprises at least one of the further layers. The method further comprises distributing the at least two levels to at least two separate computing platforms and defining at least one communication interface for each of the computing platforms.

### TECHNICAL FIELD

The present disclosure relates generally to the field of data processing by means of neural networks. It relates in particular to methods for configuring and operating a neural network. The disclosure relates further to a computer program product with program code for carrying out the respective method, and to a device for configuring the neural network, to a computing platform on which part of the neural network is configured, and to a system comprising at least two computing platforms.

### BACKGROUND

Neural networks are used inter alia for classifying data or making predictions about future events. To that end, conclusions are drawn on the basis of previous events. Specific fields of application include, for example, pattern recognition (speech recognition, facial recognition, etc.), process optimisation (in industrial manufacturing methods) and quality assurance.

Owing to the very high demands in terms of computational capacity for the mentioned fields of application, the use of neural networks was for a long time limited to the research field. As a result of rapidly advancing technological development, the use of neural networks is becoming of interest for an increasingly larger circle of potential users. Nevertheless, there are computing platforms, for example mobile computing platforms such as mobile telephones and motor vehicle control units, whose computational capacity is still comparatively low and which therefore cannot fully exploit the advantages of neural networks.

A neural network generally consists of various so-called layers in which computing operations are carried out. The layers of a neural network are organised hierarchically into an input layer, any desired number of hidden layers and an output layer.

The input layer is the first layer of the network and serves to process input data, such as, for example, training data or measurement data, which are to be analysed by a trained network. The output layer is the last layer of a neural network and serves to output the results once the input data have been processed by the neural network. The hidden layers located between the input layer and the output layer serve to further process the data after the input layer.

The individual layers of a neural network are further divided into so-called nodes. The nodes of a layer are connected both to the nodes of the previous layer and to the nodes of the following layer. It will be appreciated that the input layer does not have a connection to a preceding layer and the output layer does not have a connection to a following layer.

Each of the connections between the nodes is weighted, whereby it can be determined how strongly the result of a node is considered in the next layer. The weightings of the connections are generated or adapted during training of a neural network.

In order to be able to process input data in a target-oriented manner, neural networks must be trained. Taking the example of facial recognition, this means that an operative neural network must have learned, on the basis of a large amount of images, to identify the image of a face as such. The larger the amount of training data and the quicker the neural network is able to process the training data, the more accurate the predictions, which the neural network can yield. For this reason, the training data generally comprise very large amounts of data.

The need for large amounts of data for the training of neural networks can in turn lead to problems, since the required training data are generally not freely available (e.g. owing to licensing conditions) and the acquisition of training data is mostly complex and expensive. A collection of new training data is generally likewise time-consuming (and expensive) and can additionally lead to legal problems owing to data protection guidelines. Furthermore, a collection of new training data can lead to reduced acceptance by potential users (e.g. in the case of the processing of personal data such as images for facial recognition).

In the present prior art, the mentioned problems are met in various ways. For example, finished training data sets can be purchased, but this is generally expensive. Neural networks can further be trained on special high-performance computing platforms (e.g. mainframe computers) and transferred to and used on another computing platform (e.g. a mobile telephone) with a lower computational power only after they have been trained. However, this approach makes subsequent or expanded training of the transferred neural networks very complex. In addition, the computing platform with a lower computational power must still have a sufficiently high power to ensure correct functioning of a trained neural network running thereon.

### SUMMARY

Accordingly, the object of the present invention is to provide a technique for configuring and operating a neural network which solves some or multiple of the above-described problems, or other problems.

According to a first aspect, there is provided a method for configuring a neural network which comprises multiple successive layers. The successive layers comprise an input layer, an output layer, and at least one hidden layer located between the input layer and the output layer. The method comprises partitioning the neural network into at least a first level and a second level, each comprising one of the layers or multiple of the layers succeeding one another, wherein the first level comprises at least the input layer and the second level comprises at least one of the further layers. The method further comprises distributing the at least two levels to at least two separate computing platforms and defining at least one communication interface for each of the computing platforms. The communication interface of one of the computing platforms allows a communication of a first or last layer of the respective associated level with a last layer of a preceding level or with a first layer of a following level on another of the computing platforms.

The terms “preceding” and “following” are to be understood in the direction of flow of the neural network during operation thereof. It will be appreciated that, during training of the neural network, information can be backpropagated contrary to the direction of flow.

According to one implementation, the computing platforms comprise environments in which program code, that is to say software, can be executed. The computing platforms can be both hardware- and software-based platforms or a combination thereof. Hardware-based platforms include, for example, personal computers (PCs), mobile devices (e.g. tablet computers or mobile telephones), motor vehicle control units and games consoles. Software-based platforms include, for example, an operating system, a framework, a browser, a cloud computing platform or a virtual machine.

The number of hidden layers and the distribution thereof to the levels are design decisions which can be different according to the present application. For example, each of the levels can consist of only one layer, wherein in this example at least three levels must be present in order to be able to correspondingly distribute an input layer, an output layer and one of the hidden layers located therebetween.

The communication interfaces comprise, for example, conventional network interfaces and can be both hardware- and software-based interfaces. For communication between the computing platforms, the communication interfaces can implement various communication protocols, such as, for example, the standard network protocol Transmission Control Protocol (TCP). The communication interfaces can be designed for wired or wireless communication. Combinations thereof are also conceivable in the case of a neural network that is distributed over three or more computing platforms.

In a variant according to the first aspect, the first layer of the level associated with one of the computing platforms corresponds to the last layer of the preceding level on another of the computing platforms. Additionally or alternatively, the last layer of the level associated with one of the computing platforms corresponds to the first layer of the following level on another of the computing platforms.

If the last layer and the first layer of two successive levels on separate computing platforms correspond to one another, the nodes of the layer can be partitioned so that a first part of each node is located in the last layer of the preceding level and a corresponding second part of each node is located in the first layer of the following level. Data transfer between the corresponding layers of two successive levels can thereby take place node by node (e.g. from the respective first part of a particular node on one computing platform to the respective second part of that node on the following computing platform in the direction of flow of the neural network).

In one implementation, defining the at least one communication interface comprises configuring the at least one communication interface for serialising data from the last layer of the level on one of the computing platforms into at least one data packet that is to be sent in accordance with a communication protocol and/or for deserialising serialised data for the first layer of the level on one of the computing platforms contained in at least one data packet received in accordance with a communication protocol.

Depending on the form of the neural network, the output data of the (sub)nodes of the last layer of the level in question or the sums of the weighted input data of the (sub)nodes of the last layer of the level in question can be serialised, for example. In particular, in the case of the mentioned division of nodes, the output data from the respective first part of a particular node on one computing platform can be serialised for transfer to the respective second part of that node on the following computing platform in the direction of flow of the neural network, where deserialisation then takes place.

The at least one communication interface can further be configured to send the data packets to a communication interface with which the following level on another of the computing platforms is associated. Additionally or alternatively, the at least one communication interface can be configured to receive data packets from a communication interface with which the preceding level on another of the computing platforms is associated. In particular during training (e.g. a retrospective training), the communication interfaces can also allow data transfer contrary to the direction of flow of the neural network during regular operation thereof.

When connection-oriented protocols (e.g. TCP) are used, a connection between two of the computing platforms can be initiated by the communication interfaces. Further, software- or hardware-related mechanisms or a combination of the two can be used for error detection during a transfer of data packets (e.g. known error correction methods on data transfer), in order to ensure consistency in the case of distributed computation in the neural network.

In a variant according to the first aspect, the computing platforms are configured in accordance with a client-server model. One of the computing platforms thereby functions as a client and another of the computing platforms functions as a server.

According to a variant, the computing platform functioning as the client can request computing operations relating to the neural network as a service from the computing platform functioning as the server. These computing operations can relate in particular to data preprocessed by the computing platform functioning as the client.

This preprocessing can take place in the input layer and in one or more optional hidden layers on the computing platform functioning as the client. Preprocessing in the computing platform functioning as the client anonymises the input data and can therefore serve the data protection. The results computed by the computing platform functioning as the server can be returned to the computing platform functioning as the client (e.g. for further processing or direct outputting).

The computing platform functioning as the client is, for example, an end user device such as a mobile telephone, a laptop or a motor vehicle control unit. Depending on the required computational power of the neural network, for example, a high-performance computer, a server computer or also a computing centre, which can be operated by a service provider, for example, can form the computing platform functioning as the server.

In a further variant, the computing platform functioning as the server is configured to serve multiple computing platforms functioning as a client (e.g. In parallel or in series) each providing the same at least one level. The number of computing platforms functioning as a client can thereby be scaled as desired, so that, for example, all the vehicles of a vehicle fleet can function as clients. A further example are mobile phone customers, whose mobile end devices can function as clients.

The computing platform serving as the client can receive input data for the neural network, for example, from an external data source (e.g. a user, a vehicle camera or other vehicle sensors, etc.) or on the basis of internal computations. These input data are to be processed by the neural network (after its at least initial training). In one implementation, the method comprises processing the input data in the computing platform functioning as the client in order to generate first output data, and inputting the first output data into the computing platform functioning as the server in order to generate second output data. The method further comprises returning the second output data from the computing platform functioning as the server to the computing platform functioning as the client, and providing the second output data, or third output data derived therefrom by processing, by the computing platform functioning as the client. The providing can comprise outputting (e.g. to a user) or storing internally.

In a variant, the computing platform functioning as the client comprises the first level having at least the input layer, wherein the first output data are generated by the first level. Then computing platform functioning as the server comprises the second level having at least the output layer, wherein the second output data are generated by the output layer. For example, the result of the computation of the neural network is returned from the computing platform functioning as the server to the computing platform functioning as the client.

In a further variant, the computing platform functioning as the client comprises the first level having the input layer, and the computing platform functioning as the server comprises the second level having at least one of the one or more hidden layers, wherein the second output data are generated by the last hidden layer of the second level. The computing platform functioning as the client further comprises a third level having at least the output layer, wherein the third output data are generated by the output layer. In this variant, an intermediate result is sent by the computing platform functioning as the server to the computing platform functioning as the client, for example, whereby bandwidth can be saved on transfer of the data if the intermediate result requires less storage than the end result of the neural network.

In a variant, the computing platform functioning as the server has more computational power than the computing platform functioning as the client. For example, in the case of a large number of computing platforms functioning as a client and a correspondingly required computational power of the computing platform functioning as the server, large amounts of data in the sense of big data can be acquired decentrally (on the client side) and processed centrally (on the server side). Decentralised acquisition comprises a certain preprocessing, for example in the input layer of the neural network.

In a variant, at least one of the separate computing platforms, in particular the computing platform functioning as the server, is based on a cloud computing platform. Additionally or alternatively, at least one of the separate computing platforms, in particular the computing platform functioning as the client, is based on a mobile computing platform. As already stated in the mentioned examples, the mobile computing platform comprises in a variant a vehicle-based platform (e.g. a motor vehicle control unit) or a portable computing platform (e.g. a mobile telephone).

According to some implementations, there is provided a method that comprises a random-based initialising of the neural network before it is partitioned and a training of the neural network after it has been distributed to the computing platforms.

According to further implementations, there is provided a method comprising a first training of the neural network before it is partitioned and a second training of the neural network after it has been distributed to the computing platforms.

In a variant, the first training of the neural network is based on the principle of transfer learning using a further neural network (whose learned results can be transferred, for example) or using training data for a related task. An example of the use of training data of a related task is the recognition of objects from image data in different fields of application. It is also possible to use, for example, further known methods for training neural networks, such as supervised learning or reinforcement learning. Training can further be carried out using training data that have been verified beforehand.

In a further example, the first training is carried out with the aid of a small amount of data, and the functionality of the neural network is gradually optimised by repeated training after it has been distributed to the separate computing platforms.

In a variant, training after distribution to the computing platforms comprises inputting training data into the computing platform having the first level in order to generate output data, and inputting the output data into the computing platform having the second level. The second training further comprises training the second level on the basis of the output data.

In a variant, the level having the input layer has been distributed to the computing platform functioning as the client, and the level having the other layer has been distributed to the computing platform functioning as the server. In a further variant, the output data of the first level function as an anonymised version of the training data or other data. For example, the input data are anonymised by a first processing of input data on the clients, so that, when the processed data are sent to the server, only anonymised data are sent. This variant serves to comply with data protection guidelines.

In a further variant, the training data are generated using the neural network which has undergone the first training. This allows for, for example, an inexpensive generation and, optionally, an expansion of training data sets as well as a storage of anonymised training data.

According to a further implementation, there is provided a method in which the neural network is configured for the purpose that at least one level configured on a particular computing platform can be skipped or carried out repeatedly. In one example, the levels, analogously to known connections between layers of a neural network, can have forward connections, recursive connections, backward connections or so-called skip connections.

According to a second aspect, there is provided a method for operating a computing platform on which part of a neural network which comprises multiple successive layers is configured, wherein the successive layers comprise an input layer, an output layer, and at least one hidden layer located between the input layer and the output layer. The neural network is thereby partitioned into at least two levels each comprising one of the layers or multiple of the layers succeeding one another, wherein the first level comprises at least the input layer, and the second level comprises at least one of the further layers. The at least two levels are thereby distributed to at least two separate computing platforms, and at least one communication interface is defined for each of the computing platforms. The method further comprises the following step, which is carried out by one of the computing platforms. The method comprises communicating of a first or last layer of the level associated with that computing platform, v/a the communication interface, with a last layer of a preceding level or with a first layer of a following level on another of the computing platforms.

In a variant according to the second aspect, the communicating carried out by one of the computing platforms via the communication interface comprises a serialising of data from the last layer of the level associated with that computing platform into at least one data packet that is to be sent in accordance with a communication protocol. Additionally or alternatively, the communication can comprise a deserialising of serialised data for the first layer of the level associated with that computing platform contained in at least one data packet received in accordance with a communication protocol.

In a further variant according to the second aspect, an operation of the computing platforms in accordance with a client-server model is provided.

According to a third aspect, there is provided a computer program product having program code for carrying out the method according to one of the preceding aspects, when it is executed on the computing platforms or a computer separate therefrom. The computer program product can be stored on a computer-readable storage medium.

According to a fourth aspect, there is provided a device for configuring a neural network which comprises multiple successive layers. The successive layers thereby comprise an input layer, an output layer, and at least one hidden layer located between the input layer and the output layer, wherein the device is designed to carry out the following steps. Partitioning the neural network into at least a first level and a second level each comprising one of the layers or multiple of the layers succeeding one another, wherein the first level comprises at least the input layer, and the second level comprises at least one of the further layers. Distributing the at least two levels over at least two separate computing platforms and defining at least one communication interface for each of the computing platforms, wherein the communication interface allows a communication of a first or last layer of the respective associated level with a last layer of a preceding level or with a first layer of a following level on another of the computing platforms.

In a variant according to the fourth aspect, the device is designed to carry out a method according to the first aspect.

According to a fifth aspect, there is provided a computing platform on which a part of a neural network comprising multiple successive layers is configured, wherein the successive layers comprise an input layer, an output layer, and at least one hidden layer located between the input layer and the output layer. The neural network is thereby partitioned into at least a first level and a second level each comprising one of the layers or multiple of the layers succeeding one another, wherein the first level comprises at least the input layer, and the second level comprises at least one further layer. The computing platform further comprises at least one of the levels and at least one communication interface allowing a first or last layer of that level to communicate with a last layer of a preceding level or with a first layer of a following level on another of the computing platforms.

In a variant according to the fifth aspect, the computing platform is designed as a client or as a server in accordance with a client-server model.

The computing platform can be designed for serialising data from the last layer of the level associated with that computing platform into at least one data packet that is to be sent in accordance with a communication protocol. Additionally or alternatively, the computing platform can be designed for deserialising serialised data for the first layer of the level associated with that computing platform contained in at least one data packet received in accordance with a communication protocol.

According to a sixth aspect, there is provided a system comprising at least two computing platforms according to the fifth aspect, wherein a first of the computing platforms is configured as a client and a second of the computing platforms is configured as a server in accordance with a client-server model.

In a variant according to the sixth aspect, the system comprises multiple computing platforms configured as a client and designed for communication with the computing platform configured as the server.

### BRIEF DESCRIPTION OF THE DRAWINGS

Further features and advantages of the technique presented herein will become apparent from the drawings and also from the following detailed description of exemplary embodiments. In the drawings:

FIG. 1 shows a schematic representation of a neural network;

FIG. 2A shows a schematic representation of a neural network which is partitioned into levels and distributed over separate computing platforms with associated communication interfaces;

FIG. 2B shows a schematic representation of the serialisation and deserialisation of data on communication in a partitioned and distributed neural network;

FIG. 2C shows a schematic representation of a partitioned and distributed neural network in which the last layer of one level corresponds to the first layer of a following level;

FIG. 3 shows a schematic representation of two computing platforms in accordance with a client-server model, comprising a neural network partitioned into two levels;

FIG. 4 shows a schematic representation of two computing platforms in accordance with a client-server model, comprising a neural network partitioned into three levels;

FIG. 5 shows a schematic representation according to which a computing platform functioning as a server is configured to serve multiple computing platforms functioning as a client;

FIG. 6 is a flow diagram of a method for configuring a neural network;

FIG. 7 is a flow diagram of a method for data processing by a neural network configured according to the first aspect;

FIG. 8 is a flow diagram of a method for training a neural network;

FIG. 9 is a flow diagram of a method for operating a computing platform on which a part of a neural network is configured;

FIG. 10 is a flow diagram of a method for recursive and backward connections in a neural network; and

FIG. 11 is a flow diagram of a method for so-called skip connections in a neural network.

### DETAILED DESCRIPTION

In the detailed description, corresponding reference numerals denote identical or similar components and functions.

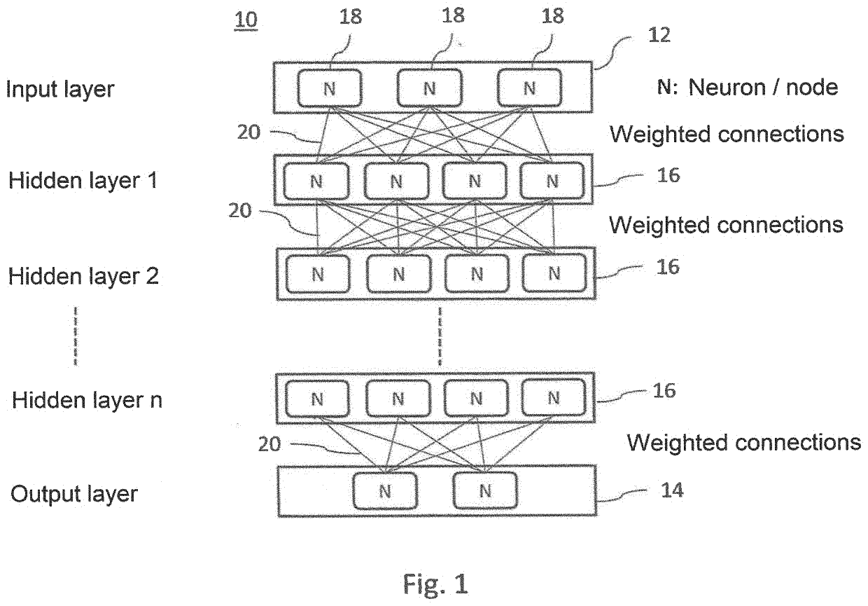

The general structure of a neural network 10 will first be explained hereinbelow with reference to FIG. 1. A neural network 10 so structured is also used in embodiments of the present invention.

The neural network 10 shown in FIG. 1 comprises multiple successive layers, wherein the successive layers comprise an input layer 12, an output layer 14, and multiple hidden layers 16 located between the input layer 12 and the output layer 14. The data received by one of the layers 12, 14, 16 are processed in the respective layer 12, 14, 16 by algorithms in a manner known per se.

The individual layers 12, 14, 16 each comprise multiple so-called nodes 18 (labelled only for the input layer 12 in FIG. 1), which symbolise neurons. The nodes 18 of one layer are thereby connected to the nodes 18 of a (possible) preceding layer and of a (possible) following layer via connections 20. The connections 20 between the nodes 18 are weighted connections 20. The weighting of an individual connection 20 between two nodes 18 arranged in different layers 12, 14, 16 usually arises during a training phase of the neural network 10. However, it is also conceivable within the scope of some embodiments of the present teaching to initialise (and optionally further train) the connections 20 on the basis of training results of another neural network.

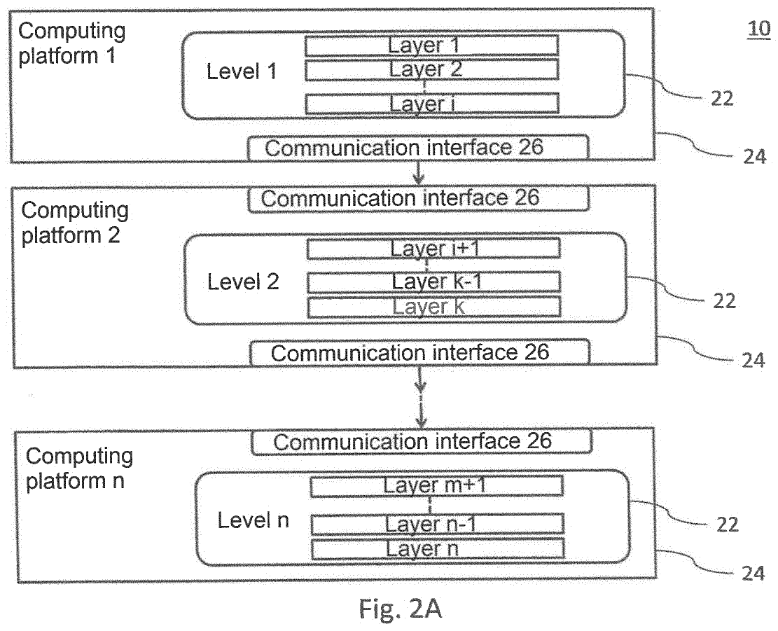

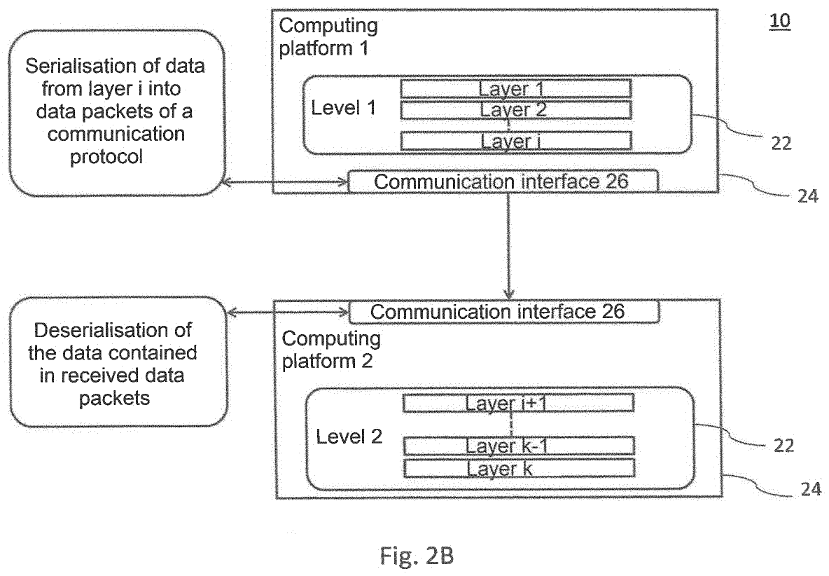

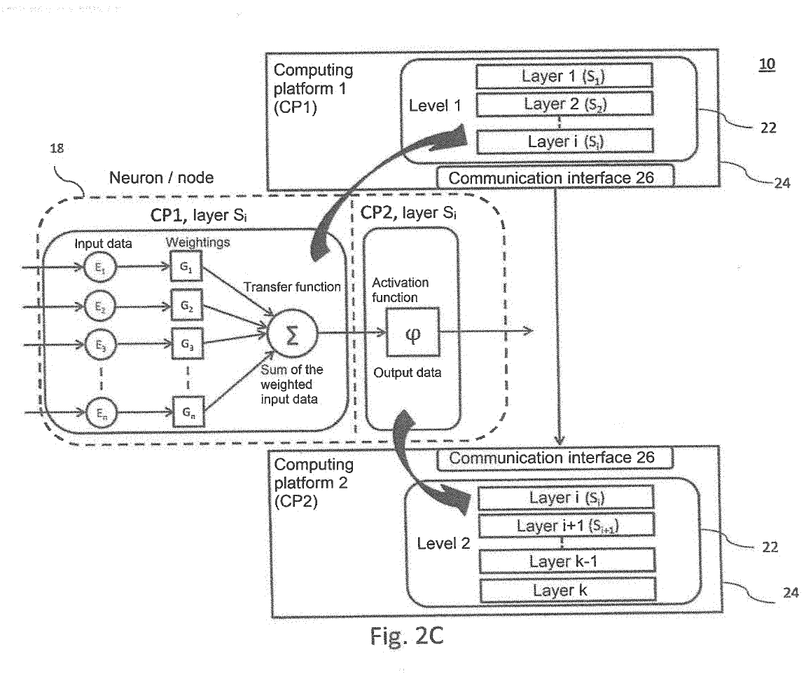

Various exemplary embodiments of a neural network 10 are described hereinbelow in relation to FIG. 2A to 4. The corresponding neural network 10 is thereby partitioned into multiple levels 22, wherein the exact division of the layers is based on design decisions in relation to the particular planned application.

FIG. 2A shows a schematic representation of a neural network 10 that, according to one exemplary embodiment, is partitioned into a number n of levels 22 and distributed to separate computing platforms 24 with associated communication interfaces 26. Each level 22 can thereby be considered as a logical container for one or more successive layers 12, 14, 16.

In the example case shown in FIG. 2A, each level 22 comprises multiple layers, and the various levels 22 are each located on various computing platforms 24. Each computing platform 24 is a hardware- or software-based platform (or a combination thereof), which allows program code, that is to say software, to be executed. Corresponding examples include personal computers (PCs), mobile devices (e.g. tablet computers or mobile telephones), motor vehicle control units, games consoles, embedded systems and combinations thereof. Software-based platforms 24 include, for example, operating systems, browsers, cloud computing platforms, virtual machines and combinations thereof.

For each computing platform 24 there is defined at least one communication interface 26, which allows a first layer of the (at least one) level 22 associated with that computing platform 24 to communicate with a last layer of a preceding level 22 on another of the computing platforms 24 (with the exception of the input layer, see reference numeral 12 in FIG. 1). Alternatively or additionally, there is defined for each computing platform 24 at least one communication interface 26 which allows a last layer of the (at least one) level 22 associated with that computing platform 24 to communicate with a first layer of a following level 22 on another of the computing platforms 24 (with the exception of the output layer, see reference numeral 14 in FIG. 1). Computing platforms 24 with hidden layers (see reference numeral 16 in FIG. 1) can also comprise a communication interface 26 on the input side and a communication interface on the output side.

The definition of the at least one communication interface 26 comprises configuring the at least one communication interface 26 for serialising data from the last layer of at least one of the levels 22 into one or more data packets of a communication protocol. Additionally or alternatively, the definition of the at least one communication interface 26 comprises configuring the at least one communication interface 26 for deserialising the data contained in one or more received data packets of the communication protocol. These aspects will be discussed in greater detail hereinbelow.

In FIG. 2A, the communication interfaces 26 of computing platforms 1 and 2, for example, permit communication between layer i of level 1 and layer i+1 of level 2. The output data of level 1, after processing in the last layer i, are thereby sent as input data to the first layer i+1 on computing platform 2. Communication according to this example can continue by means of the neural network 10 as a whole. The data output by the very last layer n of the neural network 10 are the output data, which reflect the final result of processing by the neural network 10 as a whole.

The communication interfaces 26 comprise, for example, network interfaces and can be both hardware- and software-based interfaces. For communication between the computing platforms 24, various communication protocols, such as, for example, the a standard network protocol like TCP can be used with the aid of the communication interfaces 26. The communication interfaces 26 can be designed for wired or wireless communication between the computing platforms 24. Combinations thereof are also conceivable in the case of a neural network 10 that is distributed over three or more computing platforms 24.

FIG. 2B shows an example of a neural network 10 which according to an exemplary embodiment is partitioned into two levels 22 and distributed to two separate computing platforms 24. The communication interface 26 of computing platform 1 which is shown is thereby configured for serialising data from layer i into data packets of a communication protocol. In this example, the communication interface 26 of computing platform 1 can further send the data packets to the communication interface 26 of the following computing platform 2. The communication interface 26 of computing platform 2 is thereby configured for deserialising the data contained in the received data packets of the communication protocol.

When connection-oriented protocols (e.g. TCP) are used, a connection between the two computing platforms 24 shown in FIG. 2B can additionally be initiated. Further, software- or hardware-related mechanisms or a combination of the two can be used for error detection during a transfer of data packets (e.g. known error correction methods on data transfer), in order to ensure consistency in the case of distributed computation in the neural network.

FIG. 2C shows schematically a further exemplary embodiment of a neural network 10 which is partitioned into two levels 22 and distributed to two separate computing platforms 24. In this example, a variant is shown in which the last layer (Sᵢ) of level 1 on computing platform 1 corresponds to the first layer (likewise Sᵢ) of the following level 2 on computing platform 2. In this case, on partitioning of the neural network, the nodes 18 (see FIG. 1) of layer i are partitioned into two subnodes, as shown in FIG. 2C. It will be appreciated that layer i comprises a plurality of such nodes 18, all of which are correspondingly partitioned.

The node 18 shown by way of example in FIG. 2C receives the input data (E₁ to Eₙ) from the node 18 of the previous layer S(Sᵢ₋₁, not shown in FIG. 2C). These are first weighted individually using weightings (G₁ to Gₙ). A so-called transfer function Σ then generates the sum of the weighted input data. The sum of the weighted input data is processed by a so-called activation function φ, and output data of the node 18 are thereby generated.

The partitioning of the node 18 for distribution to the corresponding layers i on the two computing platforms 1 and 2 typically takes place between the transfer function Σ and the activation function φ, so that the first part of the node 18 shown is present up to and including the transfer function Σ in layer Sᵢ of level 1 on computing platform 1 and the second part, which comprises the activation function φ, is present in layer Sᵢ of level 2 on computing platform 2. The serialisation of data (here: of the data generated by the transfer function Σ) by the communication interface 26 of computing platform 1 for transmission to computing platform 2, and correspondingly also the deserialisation of the data contained in the data packets subsequently received by computing platform 2 (namely by the communication interface 26 of computing platform 2 for subsequent further processing by the activation function φ), takes place node by node in this example.

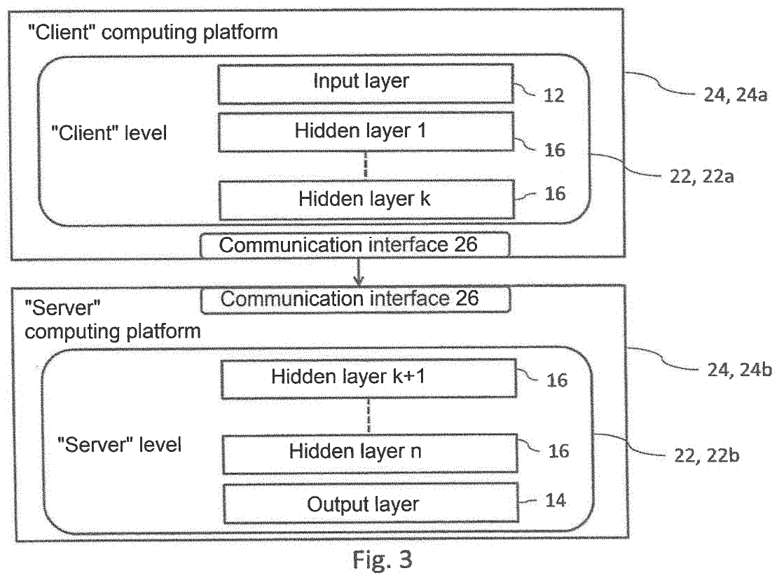

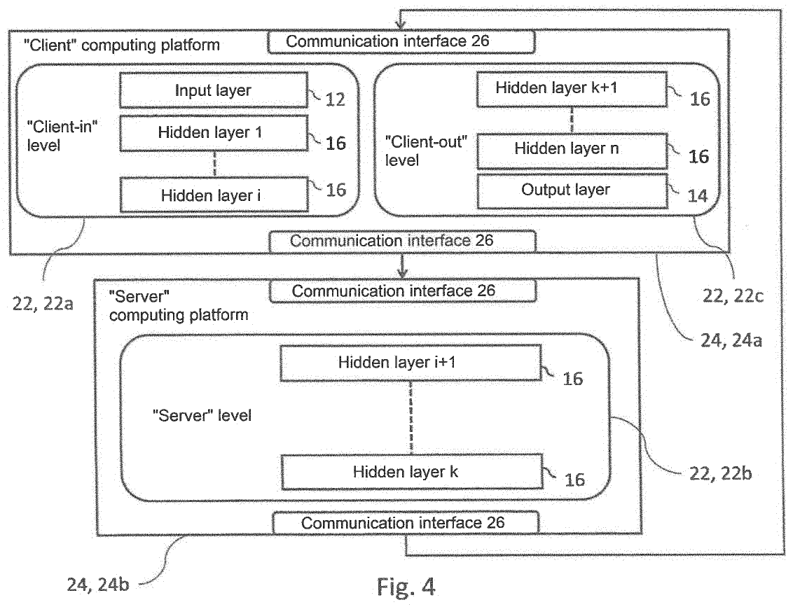

FIGS. 3 and 4 show schematic representations of two computing platforms 24 according to exemplary embodiments which are configured in accordance with a client-server model. One of the computing platforms 24 thereby functions as a client 24a, and the other of the computing platforms 24 functions as a server 24b. In a variant in accordance with the client-server model, the computing platform 24 functioning as the client 24a can request computing operations relating to the neural network as a service from the computing platform 24 functioning as the server 24b. These computing operations can relate in particular to data preprocessed by the computing platform 24 functioning as the client 24a. This preprocessing can take place in the input layer 12 and in one or more optional hidden layers 16 on the computing platform 24 functioning as the client 24a. The preprocessing thereby anonymises the data inputted into the input layer 12, before the preprocessed data are outputted to the computing platform 24 functioning as the server 24b for further processing in following layers. The results obtained by the computing platform 24 functioning as the server 24b can be returned to the computing platform 24 functioning as the client 24a (e.g. for further processing or direct outputting) or can be outputted directly or stored by the computing platform 24 functioning as the server 24b.

In one embodiment in accordance with a client-server model, the computing platform 24 functioning as the server 24b (as a first hardware platform) has more computational power than the computing platform 24 functioning as the client 24a (as a second hardware platform). The computing platform 24 functioning as the client 24a is, for example, an end user device such as a mobile telephone, a laptop or a motor vehicle. Depending on the required computational power of the neural network 10, for example, a high-performance computer, a server computer or a computing centre, which can be operated, for example, by a service provider, can form the computing platform 24 functioning as the server 24b.

FIG. 3 shows a schematic representation of two computing platforms 24 in accordance with a client-server model, comprising a neural network 10 partitioned into two levels 22. In the example shown in FIG. 3, the “client” level comprises the input layer 12 and (as an option) multiple hidden layers 16. The “server” level comprises in the chosen example multiple hidden layers 16 and further comprises the output layer 14. In an arrangement according to this example, the results obtained by the computing platform 24 functioning as the server 24b can be returned to the computing platform 24 functioning as the client 24a for direct outputting (e.g. to a user) or further processing (e.g. by an embedded system such as a vehicle control unit or a mobile telephone).

FIG. 4 shows a schematic representation of two computing platforms 24 in accordance with a client-server model, comprising a neural network 10 partitioned into three levels 22. In the example shown, the “client” platform 24a comprises two levels 22. The first level 22a denoted “client-in” comprises the input layer 12 and (as an option) multiple hidden layers 16. The third level 22c denoted “client-out” comprises multiple hidden layers 16 (as an option) and the output layer 14. Accordingly, both the input layer 12 and the output layer 14 are located on the computing platform 24 functioning as the client 24a. The computing platform 24 functioning as the server 24b comprises a level 22 which comprises only hidden layers 16. In an arrangement according to this example, the intermediate results obtained by the computing platform 24 functioning as the server 24b can be returned to the computing platform 24 functioning as the client 24a for further processing.

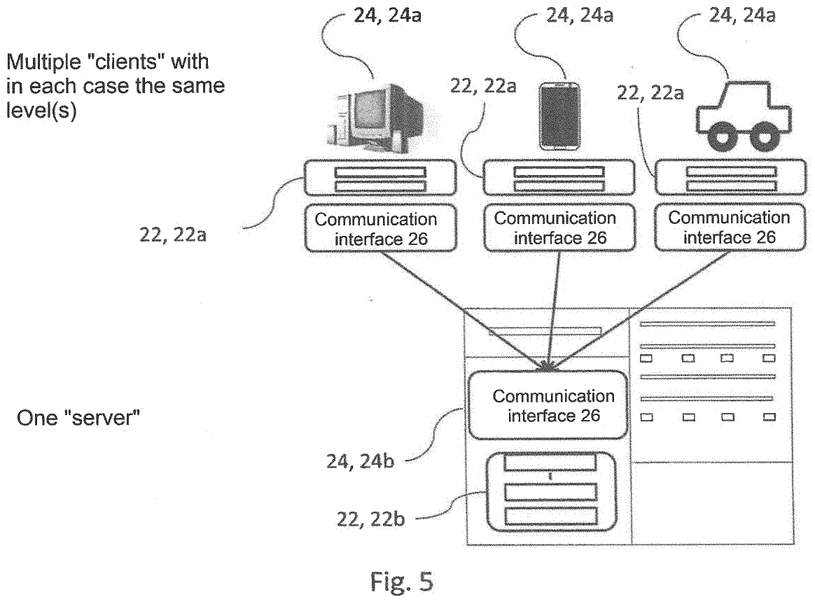

FIG. 5 shows a schematic representation of an exemplary embodiment according to which a computing platform 24 functioning as the server 24b is configured to serve multiple computing platforms 24 functioning as a client 24a. All the computing platforms 24 functioning as a client 24a thereby have their own instance of the same at least one level 22, so that each computing platform 24 functioning as a client 24a, in conjunction with the computing platform 24 functioning as the server 24b, represents the same neural network 10. FIG. 5 further shows various examples of computing platforms 24 which can function as clients 24a, such as desktop computers, mobile telephones or motor vehicles. In this example, a server computer functions as the server. It will be appreciated that the individual clients 24a can be of the same type (e.g. mobile telephone) or of various types.

In one embodiment, at least one of the separate computing platforms 24, in particular the computing platform 24 functioning as the server 24b, is based on a cloud computing platform. Additionally or alternatively, at least one of the separate computing platforms 24, in particular the computing platform 24 functioning as the client 24a, is based on a mobile computing platform. As already stated in the mentioned examples, the mobile computing platform 24 in a variant comprises a vehicle-based computing platform or a portable computing platform 24.

The number of computing platforms 24 functioning as a client 24a can be scaled as desired in this example. A possible application would be the configuration 30 of a neural network 10 for a motor vehicle fleet, in which each motor vehicle implements a client 24a. The neural network 10 can thereby be used for evaluating various data. For the example of the motor vehicle fleet, this can relate inter alia to fields of telematics, servicing or autonomous driving.

After the general description of exemplary embodiments of the level-based configuration of neural networks 10 in conjunction with various computing platforms 24, there now follow explanations of the configuration and operation of such neural networks 10.

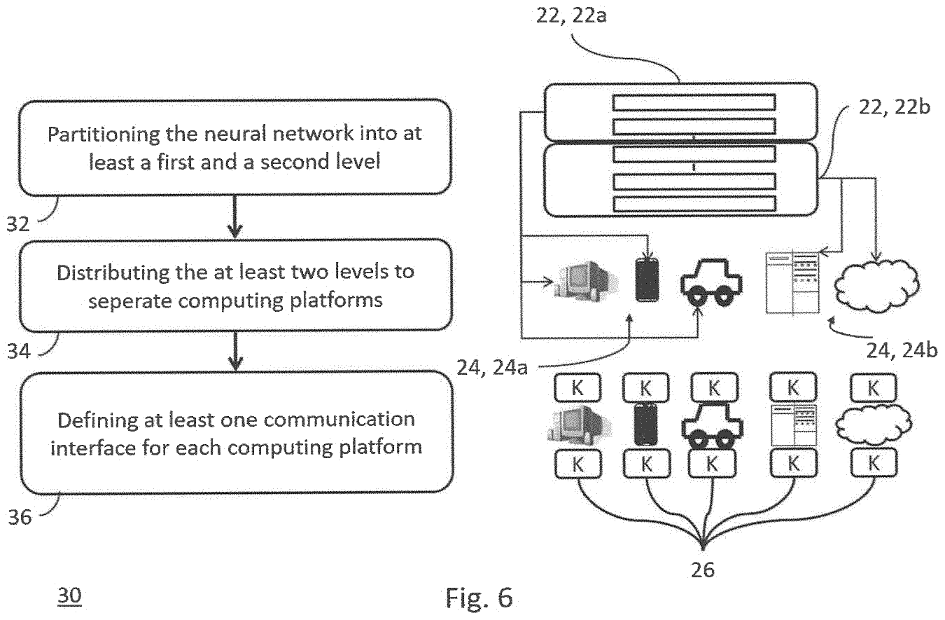

FIG. 6 shows a flow diagram 30 of an exemplary embodiment of a method for configuring a neural network 10. The corresponding steps are illustrated graphically on the right next to the flow diagram 30.

It should be noted that the neural network 10 could already have been initialised prior to configuration. The initialisation of the neural network 10 can comprise a random-based initialising network parameters (e.g. weightings of the connections 20 according to FIG. 1) or at least an initial training for determining the network parameters. The initial training can be carried out, for example, on the basis of training data verified beforehand. A training database which has a small data volume in comparison with conventional training data sets can thereby be used. Alternatively or additionally, the initial training can be based on transfer learning using a further neural network or using training data for a related task (whose network parameters can then be used at least in part in the neural network 10). An example of the use of training data of a related task is the recognition of objects from image data in different fields of application. The neural network 10 can thereby be trained on the basis of already existing comprehensive image databases, for example for driver assistance systems (recognition of objects such as road signs, vehicles and people) and transferred to another field of application, such as, for example, the segmentation of cancer cells, in order to be used there after further specialised training on the basis of an image database with a small data volume. It is also possible, for example, to use further known methods for training neural networks 10, such as supervised learning or reinforcement learning.

Referring to FIG. 6, partitioning of the neural network 10 into at least a first level 22a and a second level 22b takes place in step 32 of the method. The levels 22 shown in FIG. 5 each comprise multiple successive layers, wherein the first level 22a comprises the input layer 12, and the second level 22b comprises one or more further layers (such as one or more hidden layers 16 and/or the output layer 14).

After partitioning of the neural network 10, a distribution of the levels 22 to separate computing platforms 24 takes place in step 34. This is represented in FIG. 5 by an allocation of the levels 22 to the computing platforms 24, such as, for example, mobile telephones, motor vehicles, servers, or also to computing platforms 24 based on cloud computing.

Step 36 comprises defining communication interfaces 26 for the respective computing platforms 24, wherein at least one communication interface 26 is defined for each computing platform 24. These communication interfaces 26 permit data exchange between the separate computing platforms 24, as described above in connection with FIG. 2.

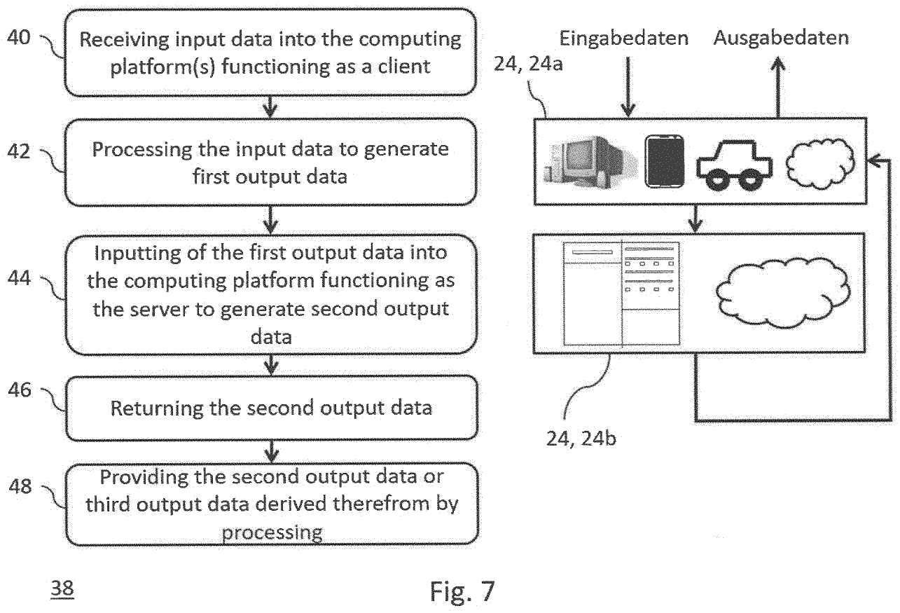

FIG. 7 shows a flow diagram 38 of an exemplary embodiment for data processing by a neural network 10, wherein in the present example a client-server model having a computing platform 24 functioning as the client 24a and a computing platform 24 functioning as the server 24b is shown (see e.g. FIG. 3 to 5). The corresponding steps are illustrated graphically on the right next to the flow diagram 38.

Step 40 comprises receiving input data by the computing platform 24 functioning as the client 24a or by multiple of the computing platforms 24 functioning as a client 24a. The input data can be received, for example, from outside (e.g. from a user, a vehicle camera or other vehicle sensor system, etc.) or on the basis of internal computations.

Processing of the input data in the first level 22a of the neural network 10 then takes place in step 42, and first output data are generated. As a result of the processing 42 of the input data by the first level 22a of the neural network 10, the generated first output data are anonymised. It is accordingly ensured, for example in the case of image recognition, that data protection guidelines are complied with, since only anonymised data are outputted by the computing platform 24 functioning as the client 24a.

Step 44 comprises inputting the output data of the first level 22a into the computing platform 24 functioning as the server 24b. The inputted data are further processed there, typically in at least one hidden layer 16, in order to generate second output data.

Step 46 comprises returning the second output data to the computing platform 24 functioning as the client 24a. If the neural network 10 consists, for example, of two levels 22, as shown in FIG. 3, then the last layer of level 22 on the computing platform 24 functioning as the server 24b is the output layer 14. The output layer 14 generates the end result of the computations of the neural network 10. If, on the other hand, the neural network 10 consists, for example, of three layers, as shown in FIG. 4, the last layer of level 22 on the computing platform 24 functioning as the server 24b is a hidden layer 16, which generates an intermediate result of the neural network 10. Depending on the embodiment, the end result or an intermediate result can accordingly be returned in the fourth step to the computing platform 24 functioning as the client 24a.

Step 48 comprises providing the returned second output data or third output data derived therefrom by processing. If an end result of the neural network 10 was returned in step 46, the end result can be outputted directly in step 48 by the computing platform 24 functioning as the client 24a (e.g. to a user or an embedded system). If, on the other hand, an intermediate result was returned, the result is further processed by a further level 22 on the computing platform 24 functioning as the client 24a. The level 22 for further processing of the intermediate result is thereby a level 22 other than the first level 22a having the input layer 12 (see FIG. 4). This variant, in which an intermediate result is returned by the computing platform 24 functioning as the server 24b to the computing platform 24 functioning as the client 24a, is advantageous especially when the intermediate result comprises significantly smaller amounts of data than the end result, since bandwidth can accordingly be saved on data transfer.

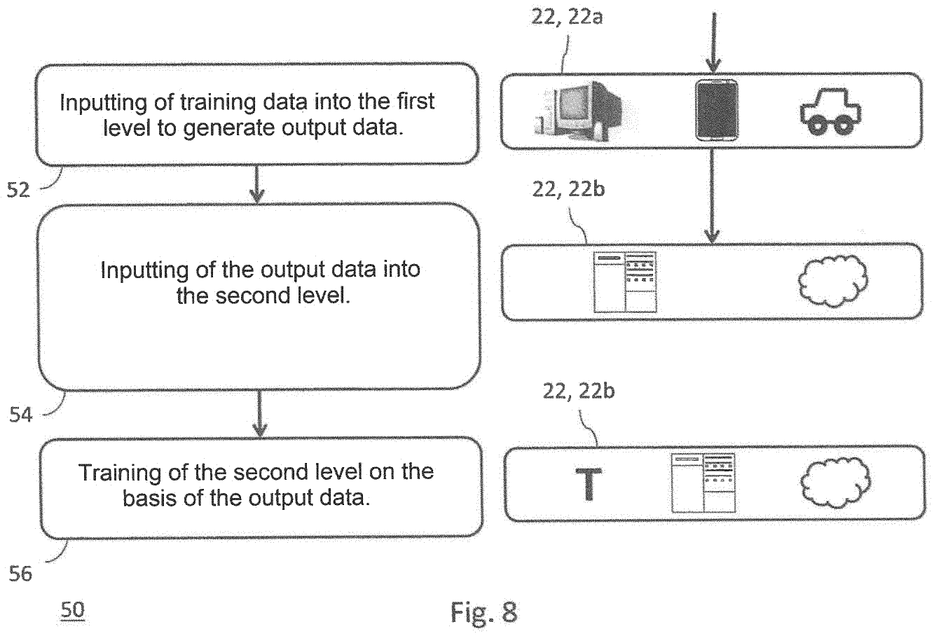

An exemplary embodiment of a method for training a neural network 10 is shown in FIG. 8 in a flow diagram 50. The corresponding steps are illustrated graphically in FIG. 8 on the right next to the flow diagram 50.

In the method shown, inputting of training data into the computing platform 24 having the first level 22a takes place in step 52 in order to generate output data. The training data can thereby be generated by the computing platform 24, which comprises the first level 22a, itself. For example, the training data comprise images from a camera of a mobile telephone or of a motor vehicle. As discussed above, the output data are thereby an anonymised version of the training data. This anonymised version of the training data can be stored in order to be available as training data for future training. Accordingly, anonymised training data can be acquired simply and inexpensively, or existing training data can be expanded in order to allow a larger amount of data to be made available for training.

Step 54 comprises inputting the output data into a computing platform 24 having the second level 22b.

In step 56, training of the second level 22b takes place. This training can be carried out gradually, optionally with different training data, in order to gradually increase the functionality of the neural network.

In one exemplary embodiment, in which multiple levels 22 on different computing platforms 24 follow the first level 22a, all the following levels 22 can also be trained. The output data of the respective preceding level 22 thereby serve as input data of the respective following level.

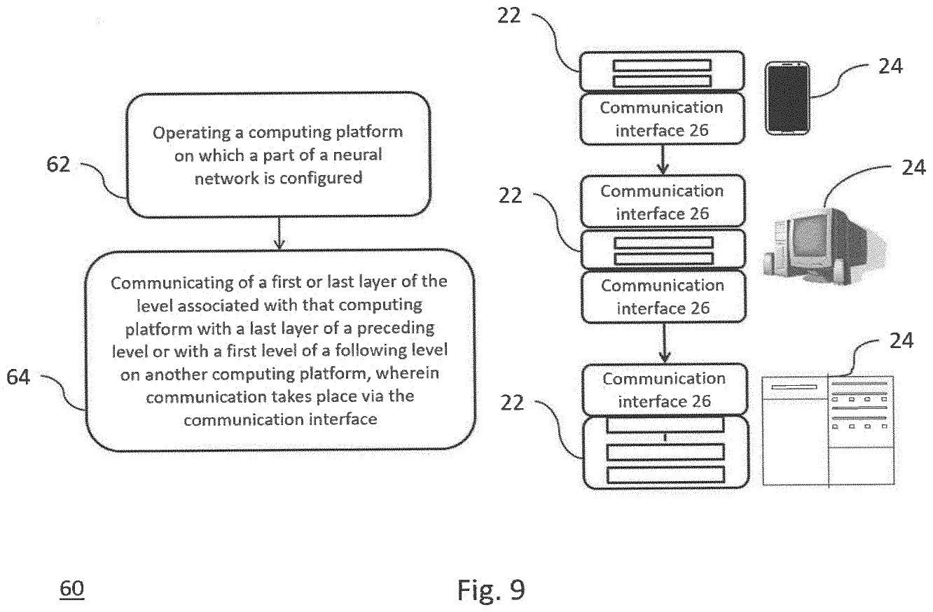

In FIG. 9 a flow diagram 60 of an exemplary embodiment of a method for operating at least one computing platform 24, on which part of a neural network 10 is configured, is shown.

Step 62 of the method shows the operation 60 of a computing platform 24 which comprises parts of an already configured neural network 10. The computing platform 24 can comprise, for example, the first level 22a having the input layer 12, or a following level 22b.

In step 64, the communicating between a first or last layer of the level 22 associated with that computing platform 24 and a last layer of a preceding level 22 or a first layer of a following level 22 on another computing platform 24 is shown. This communicating takes place via the communication interface 26 of the respective computing platform 24 and can, as described in detail in the remarks relating to FIGS. 2B and 2C, comprise a serialising of data and, additionally or alternatively, a deserialising of at least one data packet (not shown in FIG. 9).

Operating of the computing platform 24, or of the computing platforms 24, and communicating between the computing platforms 24 can thereby be carried out, for example, by service providers or users independently of the configuring (see FIG. 6) of the neural network 10. Accordingly, the configuring and the operating of the computing platform 24 can take place at various locations.

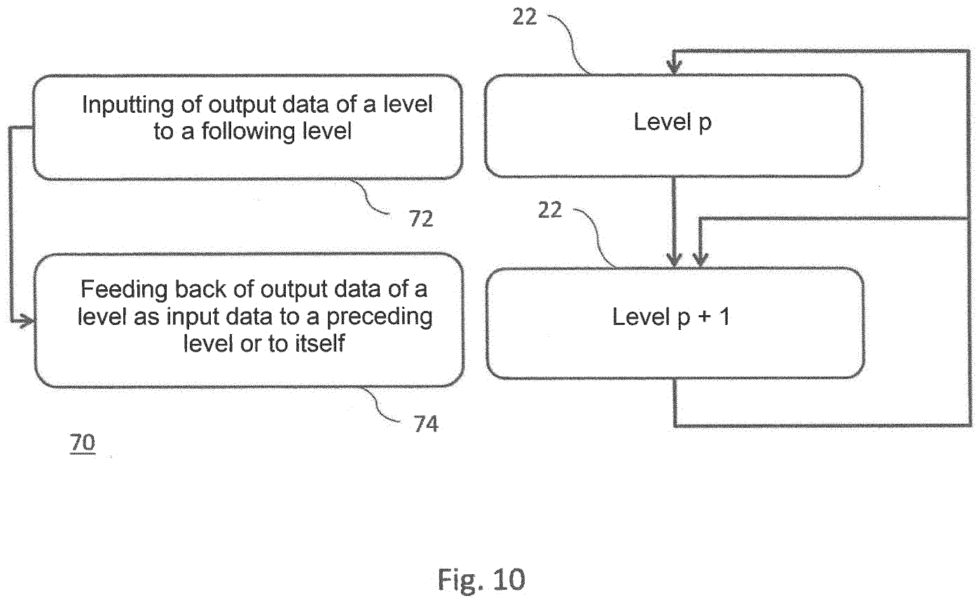

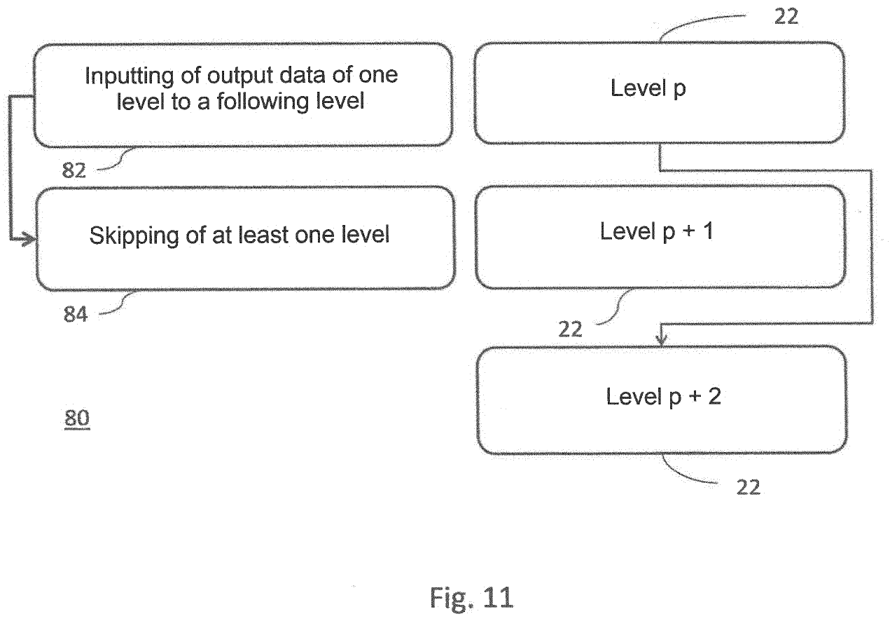

FIGS. 10 and 11 show flow diagrams 70, 80 for a method according to exemplary embodiments in which the communication between the levels 22 of the neural network 10 does not proceed solely successively in a forward direction. The corresponding steps are illustrated graphically on the right next to the respective flow diagram 70, 80.

FIG. 10 shows a flow diagram 70 of a method for recursive and backward connections 20 in a neural network 10. Step 72 illustrates the inputting of output data of a level p to a following level p+1. The following level p+1 processes the data and outputs them again, wherein the output data of level p+1 are fed back in a step 74 to a preceding level (e.g. level p) or (e.g. selectively, for example in dependence on the occurrence of a specific condition) to itself.

These recursive and backward connections 20 allow, for example, at least one selected level 22 (having possibly multiple layers) of the neural network 10 to be passed through multiple times, analogously to modes of functioning of recursive and backward connections 20 of individual layers in neural networks that are known per se.

FIG. 11 shows a flow diagram 80 of a method for so-called skip connections in a neural network 10. In step 82, the output data of a level p are inputted into a following level p+2, wherein at least one level p+1 lying therebetween is skipped (e.g. selectively, for example in dependence on the occurrence of a specific condition), which is shown in step 82. The output data are accordingly not inputted from level p into the directly following level p+1.

The skip connections 20 are used, for example, when there are multiple levels 22, in order to skip at least one level 22 (having possibly multiple layers) that does not have a major influence on the computation of the neural network 10, in order, for example, to increase the speed of the computation. Similar skip connections 20 are already known per se in single layers in conventional neural networks.

As has become apparent from the description of the exemplary embodiments, the approach presented here makes it possible to solve a plurality of problems, which in some cases are linked. Thus, problems associated with the need for (In some cases) large amounts of data for the training of neural networks can be solved. Further, data protection concerns (e.g. In respect of an anonymization) can be met. The approach presented herein makes the subsequent or expanded training of neural networks very simple. Computing platforms with a comparatively low computational power can also profit from the advantages of neural networks. Furthermore, a flexible load distribution is possible in connection with the computations of a neural network.

1. A method for configuring a neural network which comprises multiple successive layers, wherein the successive layers comprise an input layer, an output layer, and at least one hidden layer located between the input layer and the output layer, wherein the method comprises the following steps:
partitioning the neural network into at least a first level and a second level each comprising one of the layers or multiple of the layers succeeding one another, wherein the first level comprises at least the input layer, and the second level comprises at least one of the further layers;
distributing the at least two levels to at least two separate computing platforms; and
defining at least one communication interface for each of the computing platforms, wherein the communication interface of one of the computing platforms allows a communication of a first or last layer of the respective associated level with a last layer of a preceding level or with a first layer of a following level on another of the computing platforms.

2. The method according to claim 1, wherein
at least one of the following conditions holds:
the first layer of the level associated with one of the computing platforms corresponds to the last layer of the preceding level on another of the computing platforms; and
the last layer of the level associated with one of the computing platforms corresponds to the first layer of the following level on another of the computing platforms.

3. The method according to claim 2, wherein
individual layers of a neural network are further divided into nodes; and
wherein the nodes of the corresponding layers of two successive levels on separate computing platforms are partitioned so that a first part of each node is located in the last layer of the preceding level and a corresponding second part of each node is located in the first layer of the following level.

4. The method according to claim 1, wherein defining the at least one communication interface comprises:
configuring the at least one communication interface for at least one of:
serialising data from the last layer of the level on one of the computing platforms into at least one data packet that is to be sent in accordance with a communication protocol; and
deserialising serialised data for the first layer of the level on one of the computing platforms contained in at least one data packet received in accordance with a communication protocol.

5. The method according to claim 1, comprising
configuring the computing platforms in accordance with a client-server model, wherein, optionally, at least one of the computing platforms functions as a client and another of the computing platforms functions as a server.

6. The method according to claim 5, wherein
the computing platform functioning as the server is configured to serve multiple computing platforms functioning as a client each providing the same at least one level.

7. The method according to claim 5, comprising
receiving, by the at least one computing platform functioning as the client, input data to be processed by the neural network after at least initial training;
processing the input data in the computing platform functioning as the client in order to generate first output data;
inputting the first output data into the computing platform functioning as the server in order to generate second output data;
returning the second output data from the computing platform functioning as the server to the computing platform functioning as the client; and
providing the second output data, or third output data derived therefrom by processing, by the computing platform functioning as the client.

8. The method according to claim 7, wherein
the computing platform functioning as the client comprises the first level having at least the input layer, wherein the first output data are generated by the first level; and
the computing platform functioning as the server comprises the second level having at least the output layer, wherein the second output data are generated by the output layer.

9. The method according to claim 7, wherein
the computing platform functioning as the client comprises the first level having at least the input layer, wherein the first output data are generated by the first level;
the computing platform functioning as the server comprises the second level having at least one of the one or more hidden layers, wherein the second output data are generated by the last hidden layer of the second level; and
the computing platform functioning as the client comprises a third level having at least the output layer, wherein the third output data are generated by the output layer.

10. The method according to claim 1, comprising
random-based initialising of the neural network before it is partitioned; and
training of the neural network after it has been distributed to the computing platforms.

11. The method according to claim 1, comprising
first training of the neural network before it is partitioned; and
second training of the neural network after it has been distributed to the computing platforms.

12. The method according to claim 11, wherein
the first training of the neural network is based on transfer learning using a further neural network or using training data for a related task.

13. The method according to claim 11, wherein
the training after the distribution to the computing platforms comprises:
Inputting training data into the computing platform having the first level in order to generate output data;
inputting the output data into the computing platform having the second level; and
training of the second level on the basis of the output data.

14. The method according to claim 13, wherein
the output data function as an anonymised version of the training data.

15. The method according to claim 13, wherein
the training data are generated using the neural network subjected to the first training.

16. The method according to claim 1, wherein
the neural network is configured so that at least one level configured on a particular computing platform can be skipped or carried out repeatedly.

17. A method for operating a computing platform on which a part of a neural network comprising multiple successive layers is configured, wherein the successive layers comprise an input layer, an output layer, and at least one hidden layer located between the input layer and the output layer, wherein the neural network is partitioned into at least a first level and a second level each comprising one of the layers or multiple of the layers succeeding one another, wherein the first level comprises at least the input layer, and the second level comprises at least one of the further layers, wherein the at least two levels are distributed to at least two separate computing platforms, and wherein at least one communication interface is defined for each of the computing platforms, wherein the method comprises the following step that is carried out by one of the computing platforms:
communicating of a first or last layer of the level associated with that computing platform, via the communication interface, with a last layer of a preceding level or with a first layer of a following level on another of the computing platforms.

18. The method according to claim 17, wherein
the communication carried out by one of the computing platforms via the communication interface comprises at least one of:
serialising data from the last layer of the level associated with that computing platform into at least one data packet that is to be sent in accordance with a communication protocol; and
deserialising serialised data for the first layer of the level on one of the computing platforms contained in at least one data packet received in accordance with a communication protocol.

19. The method according to either claim 17, comprising:
operating the computing platforms in accordance with a client-server model.

20. A device for configuring a neural network which comprises multiple successive layers, wherein the successive layers comprise an input layer, an output layer, and at least one hidden layer located between the input layer and the output layer, wherein the device is designed to carry out the following steps:
partitioning the neural network into at least a first level and a second level each comprising one of the layers or multiple of the layers succeeding one another, wherein the first level comprises at least the input layer, and the second level comprises at least one further of the layers;
distributing the at least two levels to at least two separate computing platforms; and
defining at least one communication interface for each of the computing platforms, wherein the communication interface of one of the computing platforms allows a first or last layer of the respective associated level to communicate with a last layer of a preceding level or with a first layer of a following level on another of the computing platforms.

21. A computing platform on which part of a neural network which comprises multiple successive layers is configured, wherein the successive layers comprise an input layer, an output layer, and at least one hidden layer located between the input layer and the output layer, wherein the neural network is partitioned into at least a first level and a second level which each comprise one of the layers or multiple of the layers which succeed one another, wherein the first level comprises at least the input layer, and the second level comprises at least one further layer, wherein the computing platform comprises:
at least one of the levels;
at least one communication interface which allows a first or last layer of that level to communicate with a last layer of a preceding level or with a first layer of a following level on another computing platform.

22. A system comprising at least two computing platforms according to claim 21, wherein a first of the computing platforms is configured as a client and a second of the computing platforms is configured as a server in accordance with a client-server model.
